(19) United States
(12) Patent Application Publication
(10) Pub. No.: US 2017/0357929 A1
(43) Pub. Date: Dec. 14, 2017

(54) RAILROAD PERSONNEL SCHEDULING AND MANAGEMENT SYSTEM

(71) Applicant: Electro-Motive Diesel, Inc., LaGrange, IL (US)

(72) Inventors: Alexander SHUBS, JR., Chicago, IL (US); James David SEATON, Westmont, IL (US); David Matthew ROENSPIES, Elburn, IL (US)

(73) Assignee: Electro-Motive Diesel, Inc., LaGrange, IL (US)

(21) Appl. No.: 15/178,452

(22) Filed: Jun. 9, 2016

(51) Int. Cl. G06Q 10/06; G06Q 10/10; B61L 25/02; B61L 27/00

(52) U.S. Cl. CPC G06Q 10/063112; B61L 27/0033; G06Q 10/1097; B61L 27/0011; B61L 25/021; B61L 25/025; B61L 27/0094

(57) ABSTRACT

A railroad personnel scheduling and management system is disclosed. The system may include a personnel database storing qualification data associated with a plurality of railroad personnel and a controller comprising a personnel management module and a communication module. The controller may be configured to receive railroad asset data and personnel location data via the communication module and select a primary personnel from the plurality of railroad personnel in conjunction with the personnel management module and based on the qualification data, the railroad asset data, and the personnel location data. The controller may also be configured to generate a dispatch signal based on the railroad asset data and communicate the dispatch signal to the primary personnel via the communication module.

### TECHNICAL FIELD

The present disclosure relates generally to a railroad management system and, more particularly, to a railroad personnel scheduling and management system.

### BACKGROUND

Railroad networks facilitate many freight delivery missions between numerous origins and destinations on a daily basis. Each delivery mission typically has a predetermined delivery route, which may include checkpoints at which railroad personnel, such as locomotive drivers, perform crew changeovers to allow the mission to run continuously. During a crew changeover, a replacement crew may be assembled and gathered at a checkpoint to replace the current crew, allowing the current crew to take time off to rest or return home. In some situations, rolling stock assets on a delivery mission, such as locomotives and rail cars, may experience maintenance issues requiring maintenance personnel to be dispatched to a train in the middle of a mission. In these situations, a maintenance crew is assembled and sent to the disabled train to repair the train as quickly as possible to allow it to continue its mission

In many cases, however, a delivery route may include stretches of track through remote locations that are far from maintenance facilities. It can be sometimes be difficult to assemble a replacement crew at such remote locations in a timely fashion due to scheduling complications that result from personnel transit delays and scheduling conflicts. Similarly, it can often be difficult to locate and dispatch maintenance personnel to a disabled train stopped at a remote location in a timely fashion due to personnel availability issues and transit delays. Thus, delivery missions can be delayed, which can incur financial penalties for tardiness as well as delay other missions that share the same stretch of track.

A method of scheduling a workforce is described in U.S. Patent Application Publication No. 2014/0330605 A1 of Connolly et al. that published on Nov. 6, 2014 (“the '605 publication”). Specifically, the method described in the '605 publication includes generating a schedule of tasks to be performed on an asset based on the location of workforce personnel and the location of the asset. The method includes identifying where the asset is currently located and determining the expertise of the workforce personnel needed to perform the scheduled tasks on the asset. The method includes selecting personnel that have the proper expertise and are available to perform the tasks at the scheduled times, and which are closer to the asset than one or more other personnel allowed to work on the asset.

While the method disclosed in the '605 publication may be able to select personnel based on expertise and proximity to a railroad asset, it may not be optimum. For example, the closest personnel to the asset meeting the minimum requirement to repair the asset may not always be the best suited personnel for the task and may not be the supervisor's first choice of the qualified personnel. Further, the method of the '605 publication may not account for unscheduled maintenance issues or be able to determine how to select qualified personnel based on logistical factors other than the personnel's distance from the asset and scheduled time for repair.

The disclosed railroad personnel scheduling and management system is directed to overcoming one or more of the problems set forth above.

### SUMMARY

In one aspect, the present disclosure is directed to a railroad personnel scheduling and management system. The system may include a personnel database storing qualification data associated with a plurality of railroad personnel and a controller comprising a personnel management module and a communication module. The controller may be configured to receive railroad asset data and personnel location data via the communication module and select a primary personnel from the plurality of railroad personnel in conjunction with the personnel management module and based on the qualification data, the railroad asset data, and the personnel location data. The controller may also be configured to generate a dispatch signal based on the railroad asset data and communicate the dispatch signal to the primary personnel via the communication module.

In another aspect, the present disclosure is directed to a method of scheduling and managing railroad personnel. The method may include receiving railroad asset data via a communication module, receiving personnel location data associated with a plurality of railroad personnel via the communication module, and selecting a primary personnel from a plurality of railroad personnel in conjunction with a personnel management module and based on qualification data associated with the plurality of railroad personnel, the railroad asset data, and the personnel location data. The method may also include generating a dispatch signal based on the railroad asset data and communicating the dispatch signal to the primary personnel via the communication module.

In yet another aspect, the present disclosure is directed to a railroad personnel scheduling and management system. The system may include a personnel database storing qualification data associated with a plurality of railroad personnel and a controller comprising a personnel management module and a communication module. The controller may be configured to receive railroad asset data and personnel location data via the communication module, determine one or more skills related to maintenance information indicated by the railroad asset data, and determine an estimated time of arrival associated with each of one or more of the plurality of railroad personnel to a railroad asset associated with the railroad asset data based on the personnel location data and the railroad asset data. The controller may be further configured to select a primary personnel, in conjunction with the personnel management module, from one or more of the plurality of railroad personnel with qualification data indicative of the one or more determined skills related to the maintenance information indicated by the railroad asset data and based on the associated estimated time of arrival, generate a dispatch signal based on the railroad asset data, and communicate the dispatch signal to the primary personnel via the communication module.

### BRIEF DESCRIPTION OF THE DRAWINGS

FIG. 1 is a schematic illustration of an exemplary railroad network;

FIG. 2 is a schematic illustration of an exemplary railroad personnel scheduling and management system that may be used with the railroad network of FIG. 1;

FIG. 3 is a pictorial illustration of an application platform that may be used with the personnel scheduling and management system of FIGS. 2; and

FIG. 4 is another pictorial illustration of an application platform that may be used with the personnel scheduling and management system of FIG. 2.

### DETAILED DESCRIPTION

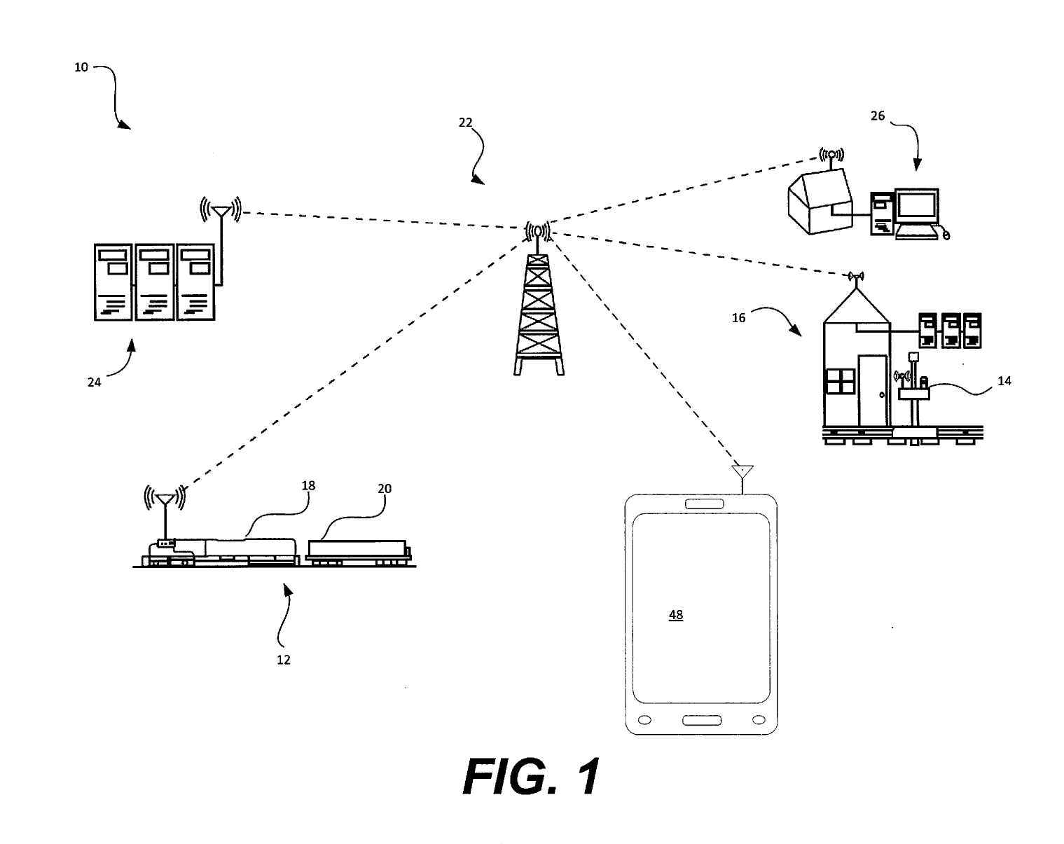

FIG. 1 illustrates an exemplary railroad network 10 that may be supported by a plurality of railroad personnel. For example, one or more trains 12 (only one train 12 shown in FIG. 1) traveling along railroad network 10 may have an onboard crew comprising a plurality of personnel, such as a conductor, an engineer, and one or more trainmen. Train crews may assigned a plurality of tasks, which may include operating train 12 along one or more legs of its delivery route within specified periods of time. Periodically, a train's crew may be changed to allow one crew time to rest while another crew takes over to allow for continuous operations. Crew changeovers may occur at predetermined times and locations along a train's travel route which may be planned to facilitate compliance with regulatory limits on daily shift time limits.

Railroad personnel may also include work gangs that perform “maintenance away,” such as repair and maintenance work on tracks and wayside equipment 14. Wayside equipment 14 may include, for example, components of an automatic train protection (ATP) signaling system 16, and may receive regular scheduled maintenance, which may be performed by work gangs. Work gangs may be assigned a plurality of tasks, which may include performing regular scheduled maintenance and/or repairs on wayside equipment 14 in a certain region within a certain period of time. Work gangs may also be dispatched to address faults or make as-needed repairs when, for example, wayside equipment 14 or other railroad assets experience a fault or sudden maintenance issue.

Wayside equipment 14 may be configured to collect and transmit wayside equipment data, which may be sent other components of railroad network 10 and received by work gangs. For instance, wayside equipment 14 may include one or more sensory devices configured to determine when a fault has occurred or when repairs and/or maintenance is required. Wayside equipment 14 may also be associated with known location information or include locating devices, such as GPS transponders, for generating location data. Maintenance information (including fault codes and other information) relating to wayside equipment 14 may be associated with the location data and communicated to other components of railroad network 10 for further processing.

Railroad personnel may also include yard personnel that perform various train building and switching tasks, among others, at a rail yard (not shown). For instance, yard personnel may be assigned tasks that include sorting cars of inbound trains based on their cargo and final destination. Yard personnel may also be tasked with assembling or building outbound trains (i.e., reconnecting cars based on their contents and final destination to for trains). Train building may also include positioning locomotives and locomotive consists throughout an outbound train to properly distribute pushing and pulling forces along the length of the train. Yard tasks may be assigned to personnel based on a yard schedule and/or as required to accommodate surges and lulls in yard activity.

Regularly scheduled and as-needed maintenance of rolling stock assets, such as locomotives 18 and cars 20 of train 12 (only one locomotive 18 and one car 20 is shown), may be performed by maintenance personnel at a maintenance shop (not shown). Maintenance shop personnel may each be assigned a plurality of tasks based on predetermined shop schedules and/or individual personnel skills. For instance, maintenance tasks may be assigned and scheduled based on the technical skills needed to complete each task. That is, tasks may be divided among electricians, mechanics, welders, and/or other types of technicians or specialists depending on task requirements.

When locomotives 18 or cars 20 experience faults or maintenance issues in the field, maintenance personnel may be dispatched to the current location of train 12 to address the fault or make as-needed repairs to allow train 12 to continue its mission. Maintenance personnel may be selected and dispatched to the affected train based on the type of maintenance issue that created the fault or necessitated the repair. Information regarding train faults and needed repairs may be generated by train 12 and communicated via communication network 22. For instance, train 12 may include an onboard control system (not shown) configured to monitor asset performance and detect when any of its assets experiences a fault. The onboard control system may communicate train asset data to other components of railroad network 10 for further processing.

Train asset data may be indicative of, for example, current and/or historic operational data, maintenance information, and location information. For instance, operational data detected by one or more sensors associated with train 12 may be recorded and transmitted for off-board processing. Maintenance information may include fault codes, health status information, fluid levels, and/or other types of information relating to train maintenance and performance levels. Maintenance information may also be indicative of types of personnel skill that may be required to address particular maintenance issues. For instance, fault codes and/or health status information may be indicative of or relate to issues involving a particular system or component of train 12 that requires repair or attention, and repairs of such system and/or component (e.g., tractions motors, engines, wheels and axles, generators, air systems, etc.) may be associated with a certain type of maintenance personnel (e.g., electrician, mechanic, etc.).

Train asset data may also include train asset location information. For instance, train 12 and/or each locomotive 18 and car 20 may include a locating device (not shown) configured to generate signals indicative of a geographical position relative to a local reference point, a coordinate system associated with a region, a coordinate system associated with Earth, or any other type of 2-D or 3-D coordinate system. Locating devices may embody electronic receivers configured to communicate with satellites or with a local radio or laser transmitting system to determine a relative geographical location of itself. Locating devices may receive and analyze high-frequency, low-power radio or laser signals from multiple locations to triangulate a relative 3-D geographical position and orientation. Train asset location information may be communicated to other components of railroad network 10 for further processing.

Train asset data may also include logistical information associated with train 12. For example train 12 may be configured to receive, store, or determine (e.g., via its control system) travel route data, estimated and/or requested times of arrival at stopover points, and origin and destination location information (e.g., locations of yards, ports, mines, plants, etc.). Logistical information may also or alternatively be generated by signaling system 16. Logistical information may be shared with other components of railroad network 10 via communication network 22 for further processing.

Additionally, signaling system 16 may be configured to collect train asset data and communicate the asset data to other components of railroad network 10 for further processing. Signaling system 16 may be configured to track the location and certain travel parameters of each train on the railroad network as they travel from one location to another, and provide signals to train operators or train control systems indicative of when to proceed and when to stop. In this way, signaling system 16 may be configured to regulate train traffic on the railroad network to facilitate the use of the network by multiple trains that share portions of track along their respective delivery routes. Signaling system 16 may track certain parameters, such as speed, distance traveled, distance between known locations (e.g., checkpoints, yards, switches, sidings, etc.), and/or other parameters for each train on the network.

Train asset data and wayside equipment data (collectively referred to as “railroad asset data”) may be collected and/or processed by a railroad network management system 24 configured to communicate with train 12 and signaling system 16 via communication network 22. Railroad network management system 24 may be a computerized system configured to centralize railroad asset data collection and processing within railroad network 10. For instance, railroad network management system 24 may include a network scheduling system and a locomotive health tracking system to coordinate network scheduling and data tracking and analysis based on information received from train 12 and signaling system 16.

The scheduling system associated with railroad network management system 24 may be used to plan train traffic schedules for one or more trains on railroad network 10 over given periods of time (e.g., daily, weekly, monthly, etc.). Origins, destinations, stopover points, and routes between them may be stored and/or determined for each train on railroad network 10 by the scheduling system of railroad network management system 24. The scheduling system may automatically determine or be used to determine changes to the train traffic schedule based on real time performance of train 12 and/or other trains on railroad network 10.

The health tracking system associated with railroad network management system 24 may be configured to track operational parameters and maintenance data associated with train 12 and/or each other train on railroad network 10. Tracked operational and maintenance information may be aggregated (e.g., organized and stored in memory) and/or analyzed (e.g., by an associated processor) to determine what types of maintenance issues have occurred, what types of future maintenance issues may occur, and when future maintenance issues may occur. The aggregated maintenance and operational information of the health tracking system associated with railroad network management system 24 may be accessible to other components of railroad network 10 via communication network 22.

Communication network 22 may be configured to facilitate data communication between different components of railroad network 10 (e.g., trains 12, signaling system 16, railroad network management system 24, etc.). Communication network 22 may include hardware and/or software that enable the sending and/or receiving of data messages through a communications link. The communications link may include satellite, cellular, infrared, WiFi, Bluetooth, radio, or any other type of wireless communication technology. Alternatively, the communications link may include electrical, optical, or any other type of wired communications, if desired. Other means of communication may also be possible.

To help facilitate the scheduling and management of railroad personnel, railroad network 10 may include a personnel scheduling and management system (“personnel management system”) 26 in communication with the other components of railroad network 10 via communication network 22. Personnel management system 26 may be a computerized system configured to receive information directly from trains 12 and signaling system 16 and/or aggregated information from railroad network management system 24. Based on information received from the other components of railroad network 10, personnel management system 26 may be configured to determine when and where personnel should be dispatched and who of the available personnel dispatch.

For instance, the travel route of train 12 may include remote stretches of track that are a substantial distance from the nearest stopover point or maintenance location. When train 12 experiences a fault or other maintenance issue at a remote location, train 12 may have to be shut down to avoid permanently disabling train 12, and maintenance personnel may have to be dispatched to repair the issue to allow train 12 to continue its mission. Due to the unexpected nature of such maintenance events, a maintenance personnel member may have to be identified from a plurality of available maintenance personnel and dispatched to the affected train 12 in a reasonable amount of time to avoid substantially delaying the mission of train 12 and/or the missions of other trains on railroad network 10. Personnel management system 26 may be configured to receive railroad asset data and personnel location data, select a primary maintenance personnel from the plurality of railroad personnel based on personnel qualification data, the railroad asset data, and the personnel location data, and generate a dispatch signal to the primary personnel via communication network 22. Personnel management system 26 may also be configured to select a backup personnel and generate a standby signal to the backup personnel to alert the backup personnel of the possibility that he or she may be dispatched to the affected train 12 in the event the primary personnel is unable to reach the affected train 12 in time.

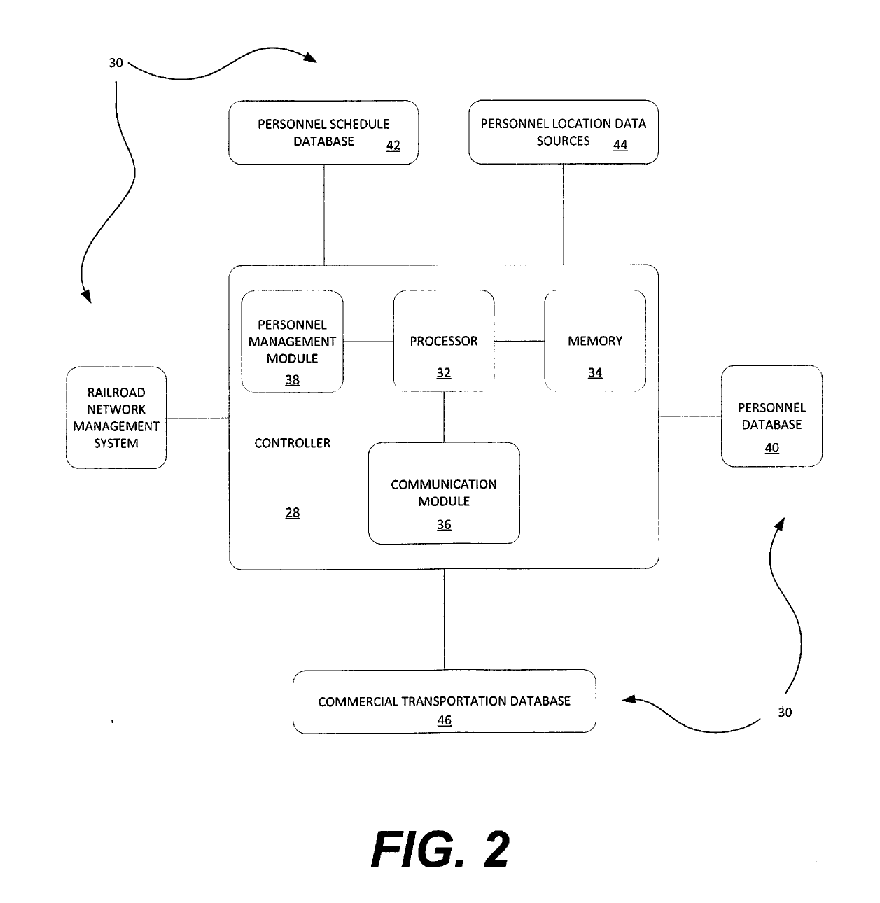

As shown in FIG. 2, personnel management system 26 may include a controller 28 in communication with a plurality of data sources 30. Controller 28 may include a processor 32, memory 34, a communication module 36, and a personnel management module 38. Data sources 30 may include, for example, railroad network management system 24, a personnel database 40, a personnel schedule database 42, one or more personnel location data sources 44, and a commercial transportation database 46. It is noted that the components of controller 28 and data sources 30 discussed herein are exemplary and are not limited to those mentioned herein.

Processor 32 may embody a single microprocessor or multiple microprocessors configured to perform computer-readable instructions stored in or associated with memory 34 and personnel management module 38. Numerous commercially available microprocessors can be configurable to perform the functions of processor 32. Memory 34 may include a non-transitory computer-readable medium, such as RAM, ROM, FLASH memory, CD ROM, magnetic devices (e.g., disks, tape, etc.), and/or other types of memory. Memory 34 may be configured to store computer-readable instructions, program information, and/or data received from other devices via communication module 36. Communication module 36 may include a combination of hardware and software and be configured to facilitate data communication between controller 28 and other electronic devices. Communication module 36 may be configured to facilitate communication via one or more electronic communication protocols, such as Wi-Fi, Bluetooth, cellular, RFID, USB, LAN, WAN, and/or others. Various other circuits may be associated with controller 28 such as power supply circuitry, signal conditioning circuitry, solenoid driver circuitry, and other types of circuitry.

Personnel management module 38 may include hardware, software, and/or combinations thereof in communication with processor 32. In some embodiments, personnel management module 38 may comprise a portion of processors 32. In other embodiments personnel management module 38 may include computer-readable instructions stored within memory 34 and configured to be executed by processor 32. In some embodiments, personnel management module 38 may be a processor or microprocessor separate from and/or in communication with processor 32 and configured to execute computer-readable instructions or programs.

Personnel management module 38 may be in communication with personnel database 40 via communication module 36. Personnel database 40 may store profile information for each railroad personnel member. For instance, personnel database 40 may store identifying information (e.g., name, employee number, etc.) and qualification data associated with each of the plurality of railroad personnel members. Qualification data stored in personnel database 40 may be indicative of one or more of a related skill and an experience level associated with or attributable to each of the railroad personnel members. The related skill and experience level may correspond to tasks that each personnel member is qualified to perform based on their job description (e.g., electrician, mechanic, welder, etc.). The experience level of each personnel member may be indicative of a proficiency level for performing related tasks. While several personnel members may possess a minimum experience level for purposes of being selected to perform maintenance on the affected train 12, some personnel members may have a higher experience level than others, which may make them more desirable. In this way, personnel management module 38 may be configured to determine which personnel members are suited to be dispatched to train 12 in the event that a particular maintenance issue arises.

Personnel management module 38 may also be in communication with railroad network management system 24 via communication module 36. In this way, personnel management module 38 may be configured to receive railroad asset data, including train asset data and wayside equipment data. That is, personnel management module may be configured to receive one or more of asset location data, travel route data, and maintenance information (e.g., fault codes, maintenance messages, historic data analyses, etc.) associated with one or more railroad assets, such as trains 12 and wayside equipment 14. In some embodiments, personnel management module 38 may alternatively be configured to receive railroad asset data directly from train 12 and/or signaling system 16. Other ways of receiving railroad asset data may be possible. In this way, personnel management module 38 may be configured to determine when train 12 is having or may have a maintenance issue as well as the nature of the maintenance issue.

Personnel management module 38 may also be in communication with one or more personnel location data sources 44 via communication module 36. Personnel location data sources 44 may include positioning systems, such as GPS positioning systems, which are configured to generate a signal indicative of a location of railroad personnel. Positioning systems may be or include handheld positioning devices (e.g., GPS transmitters) or devices that incorporate positioning technology (e.g., cellular phones, tablets, etc.). Each personnel location data source may be associated with a respective one of the plurality of railroad personnel so as to provide a unique positioning signal for each personnel member. In this way, personnel management module may be configured to determine the location of each personnel member for purposes of identifying maintenance personnel that are close enough to reach train 12 within a desired period of time when a maintenance issue arises.

When personnel management module 38 determines that a maintenance issue has occurred based on railroad asset data, personnel management module 38 may be configured to determine one or more personnel skills related to maintenance information indicated by the railroad asset data. That is, personnel management module 38 may be configured to analyze the railroad asset data and determine what type of maintenance issue exists and what type of personnel skills may be required to address it. For instance, based on the railroad asset data (e.g., a particular fault code or maintenance message), personnel management module 38 may determine, for example, that an electrician, a mechanic, or a welder is needed to address the issue. Personnel management module 38 may then identify one or more (e.g., a subset) of the plurality of railroad personnel in personnel database 40 whose qualification data is indicative of the one or more determined skills related to the maintenance information indicated by the railroad asset data. In other words, personnel management module 38 may be configured to identify which of the railroad personnel have the requisite skill and expertise for addressing the maintenance issue.

Personnel management module 38 may be configured to then determine an estimated time of arrival of each qualified personnel to train 12 based on the location of each personnel member (as indicated by the personnel location data sources 44) and the location of train 12 (as indicated by the asset location data included within the railroad asset data). Based on the estimated time of arrival and qualification data of each identified personnel, personnel management module 38 may be configured to select a primary personnel to address the maintenance issue of train 12. In some embodiments, personnel management module 38 may select the personnel having the shortest estimated time of arrival that meets the requisite qualifications. In other embodiments, personnel management module may select the personnel with the highest experience level within a maximum estimated time of arrival to train 12.

In some embodiments, personnel management module 38 may be configured to receive personnel transportation data via communication module 36 from commercial transportation database 46. In such embodiments, personnel management module 38 may be configured to determine the estimated time of arrival of one or more railroad personnel to train 12 based on their associated personnel location data as well as transportation data that may help them travel from their current location to train 12. For instance, personnel transportation data may include available flights, passenger train schedules, and traffic information, which may be used by personnel management module 38 to determine an estimated time of arrival if such commercial travel was used. In this way, personnel management module 38 may be configured to determine whether a particularly desirable personnel member (such as one with highly specialized skills or an exceptional performance record) may be available to address the maintenance issue of train 12 despite being farther away than other personnel members meeting the requisite skill level who are closer in proximity. When it is possible for a desired personnel member to avail himself or herself of commercial transportation to arrive at train 12 in a permissible amount of time, personnel management module may be configured to select such a personnel member as the primary personnel for responding to the maintenance issue.

When a suitable personnel member is identified, personnel management module 38 may be configured to then verify that the personnel member does not have a conflicting schedule conflict. For instance, personnel management module 38 may access the selected personnel's personal schedule via personnel schedule database 42 and confirm whether or not the selected personnel will have to be passed over due to a scheduling conflict. When no scheduling conflict exists, personnel management module 38 may continue with its selection. When a scheduling conflict exists, personnel management module may restart the selection process.

Personnel management module 38 may also be configured to select a backup personnel from the plurality of railroad personnel based on the qualification data, the railroad asset data, and the personnel location data. That is, personnel management module 38 may be configured to also determine a second best personnel selection using the same process as may be used to select the primary personnel, discussed above. For instance, personnel management module 38 may be configured to determine one or more skills related to maintenance information indicated by the railroad asset data and select the backup personnel from one or more other railroad personnel (i.e., other than the primary personnel) with qualification data indicative of the one or more determined skills related to the maintenance information indicated by the railroad asset data. The backup personnel may be relied on to address the maintenance issue with train 12 in the event the primary personnel is unable to complete the task (e.g., due to delay, illness, cancelled transportation accommodations, etc.).

To reduce the amount of time that may pass between the identification of a maintenance issue and the arrival of maintenance personal to resolve the issue, personnel management module 38 may be configured to pre-select primary and backup personnel based on location and scheduling data of train 12 and railroad personnel. For instance, personnel management module may be configured to receive railroad network scheduling data via communication module 36. The railroad network scheduling data may be indicative of future times and locations of stopovers along the travel route of train 12. Based on this information, personnel management module 38 may be configured to determine an estimated time of arrival associated of each railroad personnel member to a railroad asset (e.g., train 12). Based further on the qualification data and/or the transportation data of each personnel member, personnel management module 38 may be configured to predetermine a primary personnel and a backup personnel should a maintenance issue arise. That is, personnel management module 38 may periodically analyze railroad asset data, and if an asset health or maintenance pattern is detected, the pattern may be extrapolated to determine what type of maintenance issue may arise and when. In this way, personnel management module 38 may be configured to anticipate maintenance needs and predetermine which primary and backup personnel to contact should the need arise.

When primary and/or backup personnel are identified, personnel management module 38 may be configured to generate a dispatch signal for the primary personnel and a standby signal for the backup personnel and communicate the signals via communication module 36. With reference to FIG. 1, the dispatch and and/or standby signals may be communicated from personnel management system 26 to the primary and backup personnel via communication network 22. The dispatch and standby signals may be received via one or more communication devices 48 (only one communication device 48 shown). Each communication device may be associated with a respective one of the plurality of railroad personnel to allow dedicated and personalized information to be sent to each personnel member. Communication devices 48 may include, for example, cellular phones, tablets, PCs, laptop computers, PDAs, and/or other types of devices.

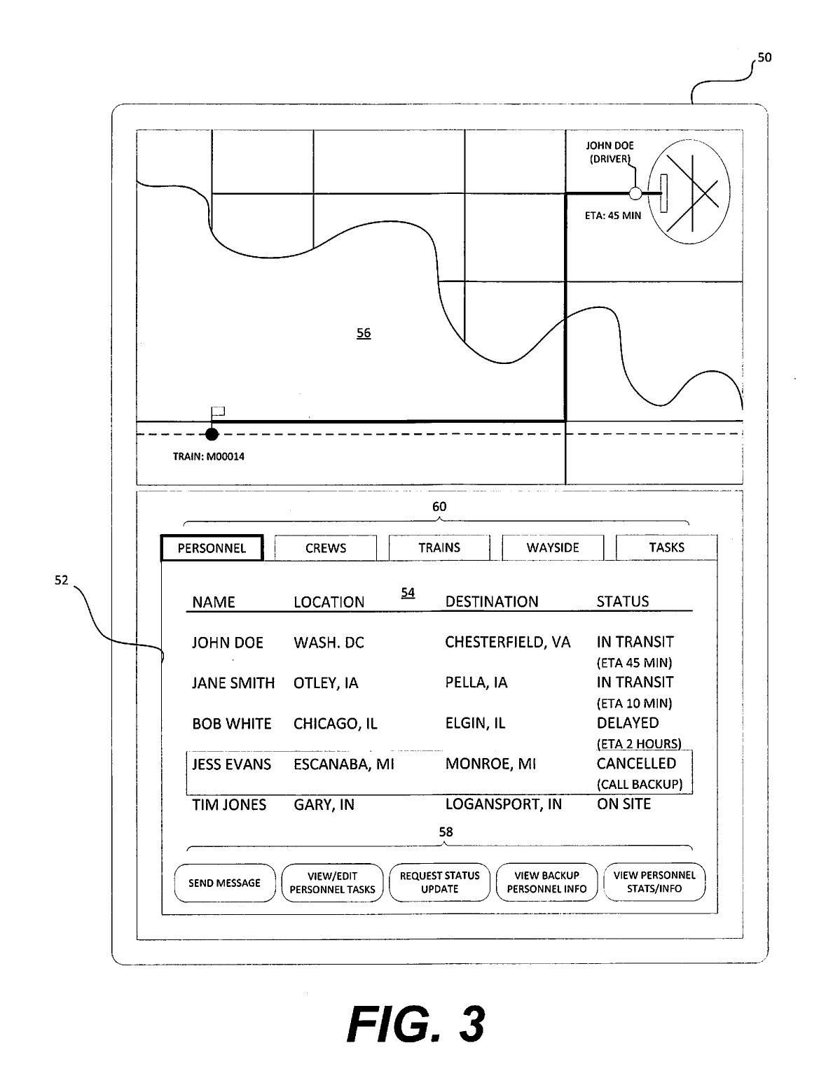

Personnel management system 26 may further include a personnel management application tool 50, as shown in FIG. 3, which may be used in conjunction with communication devices 48. Personnel management application tool 50 may include a supervisor platform 52 configured to allow railroad supervisors to monitor and manage personnel travel and task completions. For example, supervisor platform 52 may include a personnel table 54 configured to list one or more railroad personnel associated with railroad network 10. Each personnel may be selectable for viewing and/or editing personnel information.

For instance, after selecting a personnel member via table 54 in supervisor platform 52, a map 56 may appear on personnel management application tool 50 indicative of the location of the selected personnel and the location of that personnel's destination. Map 56 may include personnel identification information as well as identification information of the asset (e.g., TRAIN: M00014) to which the personnel is traveling. Supervisor platform 52 may also be configured to display travel information, such as travel status information of each personnel member in transit. Travel status information may be indicative of whether each personnel member is in transit (i.e., on-time), delayed, or whether their transportation has been cancelled. In this way, supervisors may be able to decide whether or not contact backup personnel.

Supervisor platform 52 may include other features to allow supervisors to manage other personnel aspects. For instance, supervisor platform 52 may include one or more buttons 58 or other features that may permit the supervisor to send a message to a selected personnel member, view or edit the personnel member's tasks, request a status update for the selected personnel member, view details of the selected backup personnel, and/or view statistical performance information of the selected personnel member.

Supervisor platform 52 may also include other features for managing and scheduling railroad personnel. For instance, supervisor platform may include a plurality of tabs 60 that each open different tables of information relating to personnel management. Each table may include information organized according to a different management category, such as by crew, by train, by wayside asset, or by task list. Items in each table may be selected by the supervisor in order to view location information, status information, and/or other relevant information for managing and scheduling personnel associated with each item.

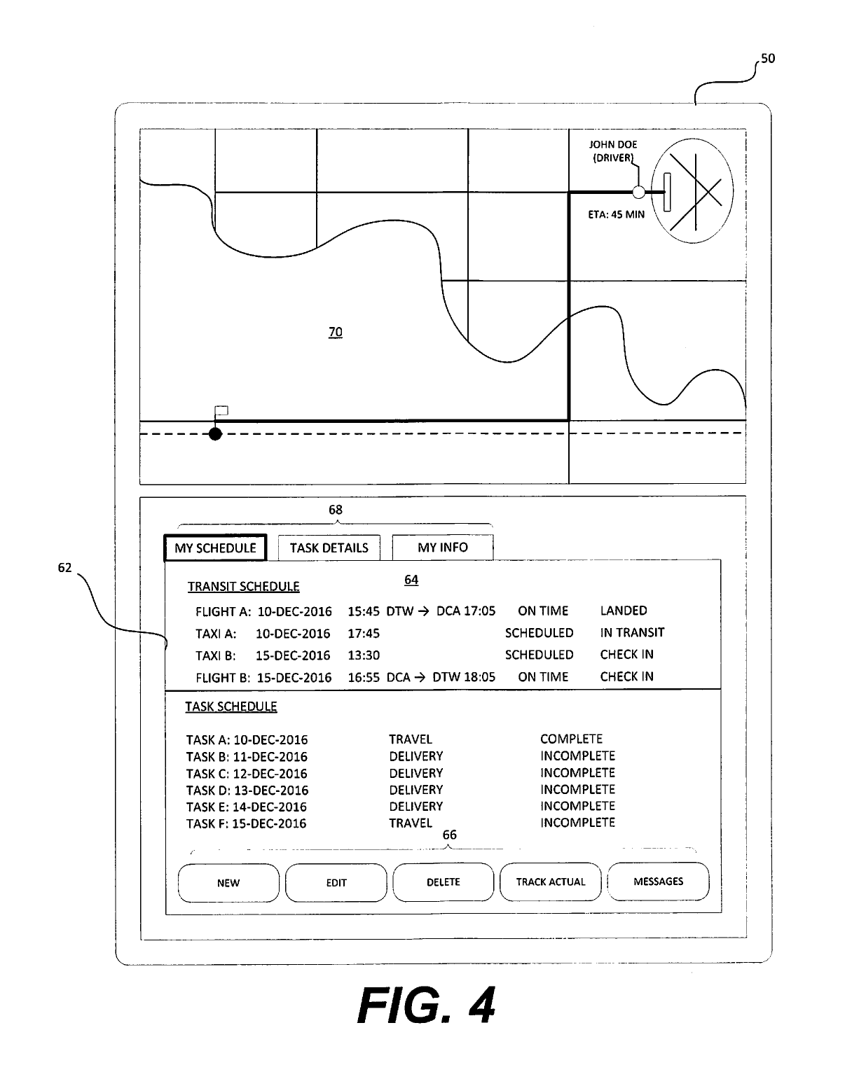

As shown in FIG. 4, personnel management application tool 50 may also include a crewmember platform 62 configured to allow railroad personnel crewmembers to view schedule, task, and travel information. Crewmember platform 62 may include interactive features that allow crewmembers to obtain desired information, check in with their supervisors, or track their performance metrics.

For example, crewmember platform 62 may include a schedule table 64 configured to list one or more schedule items, such as scheduled travel details and scheduled task details. One or more buttons 66 may be provided to allow crew members to add, edit, or delete tasks and schedule items as desired. Upon deletion or entry of schedule items, the crewmember's updated schedule may become available for viewing via the supervisor platform 52. One or more tabs 68 may be provided that lead to tables of various schedule, task, or performance information. For instance, a crewmember may be able to select a schedule item or task item, and upon selection, a map 70 may be displayed to provide a visual display of locational information, estimated time of arrival, and route guidance information. In this way, crewmembers may be able to visually track their progress with regard to transit and tasks. If a crewmember believes he or she has encountered a situation in which it will not be possible to reach the destination asset in time, the crewmember bay be able to select a button to send a message to a supervisor or backup personnel to relay pertinent information.

### INDUSTRIAL APPLICABILITY

The disclosed personnel scheduling and management system can be applicable to any railroad network that includes one or more trains supported by one or more personnel crewmembers. The disclosed personnel scheduling and management system may provide a way to identify and dispatch maintenance crewmembers at appropriate times based on a multifaceted selection process that includes location, experience, real time transit data. The disclosed personnel scheduling and management system may automatically select primary and backup maintenance personnel and provide supervisors and crewmembers with real time task and transit information via user platforms. An exemplary operation of a personnel scheduling and management system consistent with the present disclosure will now be discussed.

During operation of train 12, if a fault condition or maintenance issue arises, personnel management module 38 may detect the issue based on railroad asset data received from railroad network management system 24 via communication network 22. Personnel management module 38 may then analyze the railroad, asset data and determine what type of maintenance issue exists and what type of personnel skills may be required to address it. Personnel management module 38 may then identify one or more (e.g., a subset) of the plurality of railroad personnel in personnel database 40 whose qualification data is indicative of the one or more determined skills related to the maintenance information indicated by the railroad asset data.

Personnel management module 38 may then determine an estimated time of arrival of each qualified personnel to train 12 based on the location of each personnel member (as indicated by the personnel location data sources 44) and the location of train 12 (as indicated by the asset location data included within the railroad asset data). The estimated time of arrival may also or alternatively be determined based on personnel transportation data received from commercial transportation database 46. Based on the estimated time of arrival and qualification data of each identified personnel, personnel management module 38 then select a primary personnel to address the maintenance issue of train 12.

When a suitable personnel member is identified, personnel management module 38 may then verify that the personnel member does not have a conflicting schedule conflict by cross-checking the selected personnel's personal schedule via personnel schedule database 42 When no scheduling conflict exists, personnel management module 38 may continue with its selection.

Personnel management module 38 may then select a backup personnel from the plurality of railroad personnel based on the qualification data, the railroad asset data, and the personnel location data. The backup personnel may be relied on to address the maintenance issue with train 12 in the event the primary personnel is unable to complete the task (e.g., due to delay, illness, cancelled transportation accommodations, etc.).

When primary and/or backup personnel are identified, personnel management module 38 may be configured to generate a dispatch signal for the primary personnel and a standby signal for the backup personnel and communicate the signals via communication module 36. The dispatch and and/or standby signals may be communicated from personnel management system 26 to the primary and backup personnel via communication network 22. The dispatch and standby signals may be received via one or more communication devices 48.

A supervisor may be able to track the transit and task progress of each personnel member via supervisor platform 52 of personnel management application tool 50. Similarly, each personnel member may be able to track his or her own progress via crewmember platform 62. Crewmembers may be able to use map 70 to navigate and/or utilize route guidance during transit to train 12. When circumstances arise in which a crewmember in transit will not be able to reach train 12, the crewmember or the supervisor may be able to contact the backup personnel via personnel management application tool 50.

It will be apparent to those skilled in the art that various modifications and variations can be made to the disclosed personnel scheduling and management system without departing from the scope of the disclosure. Other embodiments of the disclosed personnel scheduling and management system will be apparent to those skilled in the art from consideration of the specification and practice of the personnel scheduling and management system disclosed herein. It is intended that the specification and examples be considered as exemplary only, with a true scope being indicated by the following claims and their equivalents.

What is claimed is:

1. A railroad personnel scheduling and management system, comprising:
a personnel database storing qualification data associated with a plurality of railroad personnel; and
a controller comprising a personnel management module and a communication module, wherein the controller is configured to:
receive railroad asset data and personnel location data via the communication module;
select a primary personnel from the plurality of railroad personnel in conjunction with the personnel management module and based on the qualification data, the railroad asset data, and the personnel location data; and
generate a dispatch signal based on the railroad asset data and communicate the dispatch signal to the primary personnel via the communication module.

2. The railroad personnel scheduling and management system of claim 1, wherein the qualification data stored in the personnel database is indicative of one or more of a related skill and an experience level associated with each of the plurality of railroad personnel.

3. The railroad personnel scheduling and management system of claim 1, wherein the railroad asset data is indicative of one or more of a location, a travel route, and maintenance information associated with one or more railroad assets.

4. The railroad personnel scheduling and management system of claim 1, wherein the personnel location data is generated by one or more positioning devices, each being associated with a respective one of the plurality of railroad personnel.

5. The railroad personnel scheduling and management system of claim 1, wherein the controller is configured to:
determine one or more skills related to maintenance information indicated by the railroad asset data; and
select the primary personnel, in conjunction with the personnel management module, from one or more of the plurality of railroad personnel with qualification data indicative of the one or more determined skills related to the maintenance information indicated by the railroad asset data.

6. The railroad personnel scheduling and management system of claim 1, wherein the controller is configured to:
receive railroad network scheduling data via the communication module;
determine an estimated time of arrival associated with each of one or more of the plurality of railroad personnel to a railroad asset associated with the railroad asset data based on the personnel location data and the railroad asset data; and
select the primary personnel based on the associated estimated time of arrival and the railroad network scheduling data.

7. The railroad personnel scheduling and management system of claim 6, wherein the controller is configured to:
receive personnel transportation data via the communication module, wherein the personnel transportation data includes one or more of flight information, traffic information, and train information; and
determine an estimated time of arrival of the primary personnel to the railroad asset associated with the railroad asset data based on the personnel transportation data.

8. The railroad personnel scheduling and management system of claim 1, wherein the controller is configured to:
select a backup personnel from the plurality of railroad personnel in conjunction with the personnel management module and based on the qualification data, the railroad asset data, and the personnel location data; and
generate a standby signal based on the railroad asset data and communicate the standby signal to the backup personnel via the communication module.

9. The railroad personnel scheduling and management system of claim 8, wherein the controller is configured to:
receive railroad network scheduling data via the communication module;
determine an estimated time of arrival of the primary personnel to a railroad asset associated with the railroad asset data based on the personnel location data and the railroad asset data;
determine an estimated time of arrival associated with each of one or more other railroad personnel to the railroad asset based on the personnel location data and the railroad asset data; and
select the backup personnel based on the estimated time of arrival of the primary personnel and the estimated time of arrival associated with each of the one or more other railroad personnel.

10. The railroad personnel scheduling and management system of claim 8, wherein the controller is configured to:
determine one or more skills related to maintenance information indicated by the railroad asset data; and
select the backup personnel, in conjunction with the personnel management module, from the one or more other railroad personnel with qualification data indicative of the one or more determined skills related to the maintenance information indicated by the railroad asset data.

11. A method of scheduling and managing railroad personnel, comprising:
receiving railroad asset data via a communication module;
receiving personnel location data associated with a plurality of railroad personnel via the communication module;
selecting a primary personnel from a plurality of railroad personnel in conjunction with a personnel management module and based on qualification data associated with the plurality of railroad personnel, the railroad asset data, and the personnel location data;
generating a dispatch signal based on the railroad asset data; and
communicating the dispatch signal to the primary personnel via the communication module.

12. The method of scheduling and managing railroad personnel of claim 11, wherein the qualification data is indicative of one or more of a related skill and an experience level associated with each of the plurality of railroad personnel.

13. The method of scheduling and managing railroad personnel of claim 11, wherein the railroad asset data is indicative of one or more of a location, a travel route, and maintenance information associated with one or more railroad assets.

14. The method of scheduling and managing railroad personnel of claim 11, wherein:
the method further includes determining one or more skills related to maintenance information indicated by the railroad asset data; and
selecting the primary personnel includes selecting the primary personnel from one or more of the plurality of railroad personnel with qualification data indicative of the one or more determined skills related to the maintenance information indicated by the railroad asset data.

15. The method of scheduling and managing railroad personnel of claim 11, further including:
receiving railroad network scheduling data via the communication module;
determining an estimated time of arrival associated with each of one or more of the plurality of railroad personnel to a railroad asset associated with the railroad asset data based on the personnel location data and the railroad asset data; and
selecting the primary personnel based on the associated estimated time of arrival and the railroad network scheduling data.

16. The method of scheduling and managing railroad personnel of claim 15, further including:
receiving personnel transportation data via the communication module, wherein the personnel transportation data includes one or more of flight information, traffic information, and train information; and
determining an estimated time of arrival of the primary personnel to the railroad asset associated with the railroad asset data based on the personnel transportation data.

17. The method of scheduling and managing railroad personnel of claim 11, further including:
selecting a backup personnel from the plurality of railroad personnel in conjunction with the personnel management module and based on the qualification data, the railroad asset data, and the personnel location data;
generating a standby signal based on the railroad asset data; and
communicating the standby signal to the backup personnel via the communication module.

18. The method of scheduling and managing railroad personnel of claim 17, further including:
receiving railroad network scheduling data via the communication module;
determining an estimated time of arrival of the primary personnel to a railroad asset associated with the railroad asset data based on the personnel location data and the railroad asset data;
determining an estimated time of arrival associated with each of one or more other railroad personnel to the railroad asset based on the personnel location data and the railroad asset data; and
selecting the backup personnel based on the estimated time of arrival of the primary personnel and the estimated time of arrival associated with each of the one or more other railroad personnel.

19. The method of scheduling and managing railroad personnel of claim 17, further including:
determining one or more skills related to maintenance information indicated by the railroad asset data; and
selecting the backup personnel, in conjunction with the personnel management module, from the one or more other railroad personnel with qualification data indicative of the one or more determined skills related to the maintenance information indicated by the railroad asset data.

20. A railroad personnel scheduling and management system, comprising:
a personnel database storing qualification data associated with a plurality of railroad personnel; and
a controller comprising a personnel management module and a communication module, wherein the controller is configured to:
receive railroad asset data and personnel location data via the communication module;
determine one or more skills related to maintenance information indicated by the railroad asset data;
determine an estimated time of arrival associated with each of one or more of the plurality of railroad personnel to a railroad asset associated with the railroad asset data based on the personnel location data and the railroad asset data; and
select a primary personnel, in conjunction with the personnel management module, from one or more of the plurality of railroad personnel with qualification data indicative of the one or more determined skills related to the maintenance information indicated by the railroad asset data and based on the associated estimated time of arrival; and
generate a dispatch signal based on the railroad asset data and communicate the dispatch signal to the primary personnel via the communication module.
